(19) United States
(12) Patent Application Publication
(10) Pub. No.: US 2015/0066229 A1
(43) Pub. Date: Mar. 5, 2015

(54) METHOD AND SYSTEM FOR CONTROLLING AN ENERGY MANAGEMENT INSTALLATION

(71) Applicant: COMMISSARIAT A L'ENERGIE ATOMIQUE ET AUZ ENERGIES ALTERNATIVES, Paris (FR)

(72) Inventors: Benoit Lacroix, Paris (FR); David Mercier, Dourdan (FR); Cédric Paulus, La Ravoire (FR)

(73) Assignee: COMMISSARIAT A L'ENERGIE ATOMIQUE ET AUX ENERGIES ALTERNATIVES, Paris (FR)

(21) Appl. No.: 14/390,339

(22) PCT Filed: Apr. 11, 2013
(86) PCT No.: PCT/EP2013/057636

§ 371 Date: Oct. 2, 2014

(30) Foreign Application Priority Data
Apr. 12, 2012 (FR) 1253371

(51) Int. Cl. G05F 1/66

(52) U.S. Cl. CPC G05F 1/66
USPC 700/295

(57) ABSTRACT

The control of an energy management installation includes an installation modelling phase (P1) comprising a step (E1) of creating a multi-agent control system including at least energy consuming, distributing and producing agents. The models of the energy distributing agents take into account characteristics concerning the distributing elements of the installation, including the energy distribution and/or consumption constraints and/or the financial and/or environmental distribution costs and/or the influence of the operation of the distributing elements on the operation of the producing elements. The control also comprises an installation regulation phase (P2) comprising an optimization step (E10) using the models incorporated in the agents to optimize the way the energy is produced by the producing agents, distributed by the distributing agents and allocated to the consuming agents.

### TECHNICAL FIELD OF THE INVENTION

The invention relates to a method and a system for controlling an energy management installation.

More particularly, one object application relates to the field of the energy management of a building or of several buildings, or of heat networks, notably the control of the thermal systems for the building(s).

### STATE OF THE ART

In a context of growing concern concerning human impacts on the environment, many approaches are focused on optimizing the energy consumption of buildings.

Thus, the document EP-A1-1635286 proposes a system for controlling energy elements, described in the form of energy consuming agents and producing agents, connected through a network enabling them to communicate. These agents can negotiate in order to determine the quantity of energy that a producing agent has to send to a consuming agent. Through a system of bids, the consumers are allocated a certain quantity of energy. The bids can in particular take into account the cost of the electricity. However, the negotiations between the agents relate only to a quantity of energy. It does not therefore make it possible to optimize the consumption of a system in which some of the producing elements have a cost which is not directly linked to the quantity produced. Furthermore, there is no provision for making it possible to optimize by different criteria. Moreover, this approach has been designed to address issues specific to electrical energy, and it cannot address the specifics introduced when certain producers produce and convey thermal energy for example via aeraulic and/or hydraulic vectors. Now, when considering thermal energy, the production of certain producers is dependent on the distribution means used: for example, the efficiency of a heat pump depends on the flow of air passing through it, a flow of air which is itself the energy transport vector. Of course, transporting agents make it possible to check the existence and the availability of a link between a consumer and an energy producer. However, they do not make it possible to take into account the distribution costs associated with the transportation of the energy. These costs can, for example, be losses, or the cost of operation of the actuators of the installation, such as the fans in aeraulics or circulators in hydraulics.

In the document WO2008/014562, a distributed system energy management architecture is proposed. It relies on different agents representing energy resources, which can communicate with one another. A specific agent, called operator agent, handles the control of the system. However, this approach is dedicated to the use of electrical energy, and does not make it possible to incorporate the physical constraints of the thermal energy distribution. Nor is it suited to controlling the energy systems of the building, which require the representation of complex and interdependent resources.

Numerous scientific publications also focus on multi-agent approaches.

A first category of approaches focuses on the energy management of buildings. For example, Abras et al “Advantages of MAS for the resolution of a power management problem in smart homes” proposes a system for controlling the energy in the home, based on a multi-agent modelling relying on a two-level mechanism: one layer ensures the reactive control of the system, and an anticipative layer handles a longer term planning. The approach is however restricted to the control of electrical systems.

Other approaches aim to take into account the behaviour of the residents (Hagras et al “A hierarchical fuzzy-genetic multi-agent architecture for intelligent buildings online learning, adaptation and control”) or the configuration of the environment (Rutishauer et al “Control and learning of ambience by an intelligent building”). However, none of them considers the thermal specifics of the building or of the apparatuses, or makes it possible to incorporate new energy sources.

A second category of approaches focuses on applications involving distribution vectors of a non-electrical nature, such as hydraulics. For example, in Davidsson et al “Embedded agents for district heating management”, a multi-agent modelling is used in order to optimize the operation of heat networks, the objective being to minimize the energy consumption of a hot water network ensuring sanitary hot water heating and production functions. The system is described in the form of producing agents, redistribution agents and consuming agents. The function of the redistribution agents is to recover the consumption of their clients and their forecasts, and to supply this information to the producing agent, which ensures the control of the demand. The approach takes into account the constraints specific to the hydraulic networks, such as the production time and the inertia of the systems. However, it considers only the viewpoint of the producing agent and is not adapted to the consumption of the individual home, which requires accurate setpoint tracking. Furthermore, since it does not rely on thermal models, it does not make it possible to incorporate alternative energy sources. Finally, its single-layer structure makes the incorporation of decentralized forms of production difficult.

Finally, recent works have focused on taking into account new heating systems, such as heat pumps (notably Rogers et al “Adaptive home heating control through Gaussian process prediction and mathematical programming”). By taking into account the predicted thermal trend of the building and the local weather forecasts, the approach makes it possible to optimize the financial cost or the carbon footprint of the installation. However, it does not incorporate the possibility of modelling all the elements ensuring the thermal comfort of the building, and does not take into account the constraints linked to the energy distribution vectors and to the consumption of the associated auxiliaries. The modelling of more complex systems, incorporating, for example, thermal solar panels and heat exchangers, cannot easily be incorporated in the approach.

Moreover, other approaches seek to resolve similar issues, but without using agent-based modelling. The document GB2448896 proposes a building management system relying on a set of sensors to estimate the thermal characteristics of the energy converters, the thermal properties of the building, its occupancy profile, and a forecast of the energy demand. Using these elements, a planning is prepared, by using a centralized optimization method, and a reactive correction is added if a deviation is observed. The proposed model takes into account certain new energy production sources, like photovoltaic solar panels and heat pumps. Nevertheless, the automatic load recognition system used for the estimation does not make it possible to take into account energy sources like thermal solar panels. Furthermore, the approach does not take into account the consumption of the distribution auxiliaries. Finally, the optimization process used is based solely on minimizing the thermal losses and does not make it possible to take into account different optimization criteria.

The document WO2011/072332 proposes a method and a system for controlling the ventilation, heating and cooling of buildings. The method relies on a thermal model of the building, and produces an optimization based on the price of the electricity, the weather forecasts and the satisfaction of the users. However, the proposed method relies only on a simplified model of the building, which does not incorporate the specifics of the different energy sources and does not make it possible to take into account the distribution auxiliaries. Furthermore, the proposed optimization method does not make it possible to optimize by different criteria and cannot be extended to include the production of sanitary hot water.

Finally, the document U.S. Pat. No. 7,783,390 describes methods and systems intended to optimize the control of the energy demand and production. The principle used is to shift the consumption of the apparatuses to the periods during which the energy is less costly and to supply the energy to the network when the price of the energy is high. However, the approach is oriented solely towards electrical resources and does not consider the thermal aspect of the building.

### OBJECT OF THE INVENTION

The aim of the present invention is to propose a solution for controlling an installation which manages energy and remedies the drawbacks listed above.

Notably, one object of the invention is to provide a solution which allows for energy management to be optimized according to different energy consumption criteria (in particular, the cost of operation and the environmental cost).

Another object of the invention is to provide a solution which takes account of the specifics of the new energy sources (thermal solar panels, heat pumps, etc.).

Another object of the invention is to provide a solution which takes account of the specifics of the energy transport vectors (in particular the hydraulic and aeraulic vectors) and their associated costs.

Another object of the invention is to provide a solution which increases the reusability of the systems developed.

These objects can be achieved through the attached claims.

In particular, a method for controlling an energy management installation comprises:
an installation modelling phase comprising:
   a step of creating a multi-agent control system including at least energy consuming, distributing and producing agents representative at least of an operation associated with respectively energy consuming, distributing and producing elements of the installation, each of the agents incorporating a model implemented by a computer,
   the models of the energy distributing agents taking into account characteristics concerning the distributing elements of the installation, including the energy distribution and/or consumption constraints and/or the financial and/or environmental distribution costs and/or the influence of the operation of the distributing elements on the operation of the producing elements,
an installation regulation phase comprising:
   an optimization step using the models incorporated in the agents of the control system so as to optimize the way the energy is produced by the producing agents, it is distributed by the distributing agents and it is allocated to the consuming agents, as a function of optimization criteria based on the energy consumption of the installation and/or on at least one other criterion such as the cost of operation and/or the environmental cost of the installation and/or weather forecasts and/or comfort parameters and/or the observed and/or expected behaviour of the users of the installation,
   a step of controlling the actuator elements of the installation based on the results of the optimization step from the implementation of the models incorporated in the agents.

A system for controlling an energy management installation can comprise software and/or hardware elements which implement the control method. In particular, it can be a management system managing either the thermal systems of a building, the consuming elements being taken from, for example, heating and/or ventilation and/or air conditioning and/or sanitary hot water production elements, or a heat network, or an installation coupling thermal energy and electrical energy.

A third aspect of the invention relates to a computer-readable data storage medium, on which is stored a computer program comprising computer program code means for implementing the phases and/or steps of the control method.

Finally, a fourth aspect of the invention relates to a computer program comprising a computer program code means suitable for carrying out the phases and/or steps of the control method, when the program is run on a computer.

### BRIEF DESCRIPTION OF THE DRAWINGS

Other advantages and features will become more clearly apparent from the following description of particular embodiments of the invention, given as nonlimiting examples and represented in the attached drawings, in which:

FIG. 1 is a schematic view describing the installation through an agent-based control system,

FIG. 2 is a flow diagram representing the successive phases and steps of an exemplary control method according to the invention,

FIG. 3 is a simplified diagram of an exemplary installation to which the solution according to the invention could be applied,

FIG. 4 is a schematic view of the methodology for modelling the installation of FIG. 3 in the form of a multi-agent control system,

FIG. 5 is a graphic representation of an exemplary algorithm implementing the main control loop of the control system (case of centralized execution) applied to the case of FIGS. 3 and 4,

FIG. 6 is a graphic representation of the different steps of the optimization process applied to the case of FIGS. 3 and 4,

FIG. 7 is a modelling of the installation of FIG. 3 in the form of a multi-agent control system,

FIG. 8 represents the values observed from the temperature sensors of the installation over a 24-hour period,

and FIG. 9 represents the controls of the different actuator elements of the installation computed by the control system over the 24-hour period.

### DESCRIPTION OF PREFERENTIAL EMBODIMENTS OF THE INVENTION

Hereinafter in the description there follows a description of a control solution, that is to say a control method and a control system, for a physical energy management installation. A non-limiting particular application targeted by the invention relates to the field of the energy management of a building, notably the control of the thermal elements or systems for the building. In other words, in this particular case, the physical installation mainly manages the thermal energy dedicated to the building based on diverse energy sources. However, the principle of the invention can be applied to any energy management installation, such as, for example, electrical energy or even a heat network installation, notably covering several buildings.

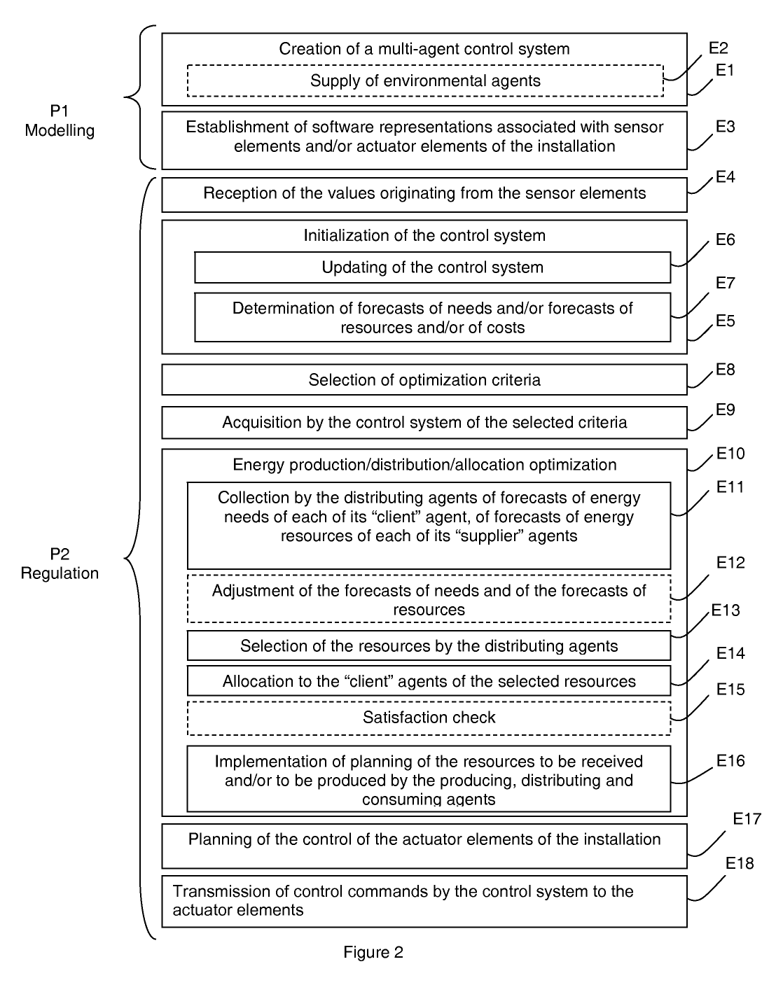

The flow diagram of FIG. 2 illustrates the optional steps using a broken-line outline.

The solution essentially provides for the design and implementation of a control system that makes it possible to control the physical elements (actuators), i.e. the apparatuses of the installation and the distribution auxiliaries, which ensure the energy functions (for example thermal functions in the building, such as heating, air conditioning, ventilation or sanitary hot water production).

Then, the duly designed control system is used to optimize the energy management of the installation according to different criteria, that can be selected by the user and based, for example, on the energy consumption of the installation and/or on at least one other criterion such as the cost of operation and/or the environmental cost of the installation.

One of the objectives of the control system is to ensure the management of the energy elements of the installation (for example the thermal elements of the building) while observing the specifications (for example the comfort of the inhabitants of the building). In the current approaches, this management of the energy elements of the installation is more often than not optimized according to the single criterion that is the total energy consumption of the installation. However, the increase in use of new thermal energy sources, such as heat pumps or thermal solar panels, as well as the profile of the purchasers of this type of element, who often have a strong environmental awareness, leads to the desire to be able to use other criteria. Thus, the control system aims to be configured to be able to provide an optimization for example on an environmental or financial cost, according to the wishes of the user.

Some energy sources have specific operating features which are not taken into account by the current methods. For example, the efficiency of a heat pump is strongly dependent on the operating conditions and on the condition of other apparatuses. In order to best optimize the control system, it is necessary to take account of this complex operation in the regulation.

Also, the energy (for example of thermal nature) is transported by specific vectors, for example hydraulic or aeraulic, via the distributing elements of the installation. Such is the case for example of the energy produced by thermal solar panels. These transport vectors imply the existence of physical connections between elements of the installation, which induce constraints in the optimization process. Furthermore, the auxiliaries ensuring the transportation of the thermal energy (fans or circulators for example) represent an increasingly large share of the energy consumption, particularly in the low-consumption or positive-energy buildings (16% on average in residential or tertiary so-called “BBC” (low energy consumption building) buildings, and up to 30% in some cases). It is therefore necessary to explicitly incorporate these constraints and these auxiliaries in the process of optimizing the installation to improve its management.

The current way that control systems are developed makes them difficult to reuse. In fact, each development is carried out specifically for a given installation. However, some elements are common between the installations, such as the management strategy or the operation of certain apparatuses. In order to facilitate the task of the designer, it is advantageous to enable him or her to reuse all or some of the elements implemented in similar installations.

The solution proposed below provides a solution to these issues.

The solution provides modelling the installation through a virtual agent-based control system, notably explicitly incorporating a modelling of the distribution network. The control system incorporates in this modelling on the one hand a model that makes it possible to compute the distribution costs associated with the transportation of the energy (these costs can be, for example, losses or the cost of operation of the actuators, such as the fans or the circulators) and, on the other hand, a process making it possible to optimize the operation of production in light of the distribution.

Globally, a physical installation managing energy consists of a set of elements which consume, produce or distribute energy. All these elements (also called “apparatuses”) are physically linked to one another by a network for distributing energy using an energy transport vector such as, for example, of an aeraulic or hydraulic nature. The installation also comprises a set of sensor elements, and a set of actuator elements. The aim is to design such a control system then to determine, at each step in time of a subsequent regulation phase P2, the status which will be assigned to each of the actuator elements of the physical installation.

Thus, as will be detailed hereinbelow, the proposed method is based on a first modelling phase P1 of the installation, in which the physical installation is described in the form of a multi-agent control system. Once this description is completed the proposed control system automatically ensures the regulation of the physical installation according to the method described in the phase P2. These two phases are detailed hereinbelow in the form of a method for controlling an installation managing energy, the steps of which are listed in FIG. 2.

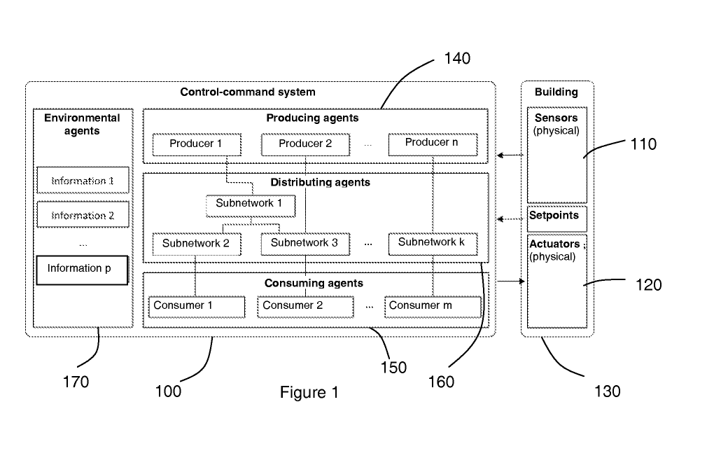

According to an essential feature, the modelling phase P1 of the installation comprises a step E1 of creating a multi-agent control system (detailed in FIG. 1) including at least energy consuming agents, energy distributing agents and energy producing agents representative at least of an operation associated with respectively energy consuming elements, energy distributing elements and energy producing elements of the installation. Each of the agents incorporates a model implemented by a computer. The models of the energy distributing agents take into account characteristics concerning the distributing elements of the installation, including the energy distribution and/or consumption constraints and/or the financial and/or environmental distribution costs and/or the influence of the operation of the distributing elements on the operation of the producing elements.

More specifically, the physical installation is first of all modelled in the form of a multi-agent control system 100 made up of different agents. To refer to FIG. 1, the control system 100 first of all contains software representations of the (physical) sensor elements 110 and of the actuator elements 120 of the physical installation (here associated with a building 130). The software representations are intended to ensure the link between the control (or command) of software type with respect to the hardware elements 110, 120.

The control system 100 also contains a representation in the form of agents of the apparatuses, of the distribution network, and of additional elements related to the system. Different types of agents are differentiated, according to their function:
an element of the installation whose function is to produce energy (for example of thermal nature) is modelled in the control-command system 100 by an energy producing agent 140 (“producer i”, i ranging from 1 to n),
an element of the installation whose function is to consume energy (for example to ensure the comfort of the occupant of the building by using thermal energy produced and distributed) is modelled in the control-command system by an energy consuming agent 150 (“consumer i”, i ranging from 1 to m),
an element of the installation whose function is to distribute energy between the producing elements and consuming elements is modelled in the control-command system by an energy distributing agent 160 (“distributor i”, i ranging from 1 to k). A distributing agent 160 thus models a sub-part of the distribution network, more often than not associated with one or more actuators of the installation. It can be considered that each distributing agent 160 of the control system is associated with at least one other agent of “supplier” type and with at least one other agent of “client” type.
finally, an element of the installation or external to the installation whose function is to provide the control system 100 with complementary information (“information i”, i ranging from 1 to p) concerning the real environment of the physical installation is modelled in the control-command system 100 by an environmental agent 170.

This modelling leads to a hierarchical representation of the installation: the producing agents are connected to the consuming agents through a hierarchy of distributing agents representing the energy transfer network. Unlike the prior art approaches, this description explicitly models the energy distribution network, associating specific properties with it. This makes it possible on the one hand to incorporate the distribution constraints (for example the fact that a flow can be conveyed only between two physically connected points) and, on the other hand, to take into account the financial distribution cost induced by this network (such as the cost associated with the consumption of the auxiliaries such as the fans or the circulators or the heat losses of a network). The environmental agents make it possible to represent additional information such as the cost associated with the energy (the cost of the electricity for example) and this information will then be used in an optimization step E10 described below.

Thus, according to an additional essential feature, the regulation phase P2 of the installation comprises:
an optimization step E10 using the models incorporated in the agents of the control system so as to optimize the way the energy is produced by the producing agents, it is distributed by the distributing agents and it is allocated to the consuming agents, as a function of optimization criteria based on the energy consumption of the installation and/or on at least one other parameter such as the cost of operation and/or the environmental cost of the installation and/or weather forecasts and/or comfort parameters and/or the observed and/or expected behaviour of the users of the installation,

a step E17, 18 of controlling the actuator elements of the installation, the way they are controlled being based on the results of the optimization step from the implementation of the models incorporated in the agents of the control-command system.

The concept of “behaviour” in the above paragraph incorporates all the useful behavioural characteristics but also the aspects linked to the presence or the absence of the users, their heating, cooling and sanitary hot water consuming habits, etc.

Each of the agents of the control-command system is thus associated with an internal model which differs according to the type of agent.

Notably, the internal model associated with each distributing agent of the multi-agent control system computes a distribution cost due to the energy transfer by the distributing agent associated with a given energy need and/or the resources necessary to the distributing agent, associated with this energy need. Furthermore, the internal model associated with each producing agent of the multi-agent control system computes necessary energy resources that the producing agent can supply to the distributing agents and/or a need for energy to be supplied to the producing agent to produce these necessary resources and/or a cost of production of the necessary resources. Finally, the internal model associated with each consuming agent of the multi-agent control system computes needs for energy to be supplied to the consuming agent and/or a satisfaction associated with resources received by the consuming agent.

These internal models can for example be energy models, which produce a budget concerning an apparatus or a subpart of the distribution network of the installation. They can also be models characterizing the operation of an apparatus as a function of external parameters. They can finally be forecast models making it possible to estimate the value or the future status of an element of the installation. The existing approaches are based only on a thermal model of the building or on the estimation of the contribution of the different apparatuses. Contrary to that, in the solution according to the invention, the incorporation of a model of operation of each of the apparatuses (producing and/or distributing and/or consuming elements) and of models representing the distribution network, makes it possible to take account of new elements, such as the contribution of thermal solar panels, the specifics of operation of the heat pumps, or the influence of the modalities for distributing produced energy, on the production of this energy.

The creation step E1 can optionally comprise a step E2 of supplying environmental agents used during the optimization step E10. These environmental agents belong to the multi-agent control system and are representative of parameters external to the installation, such as the financial cost associated with the energy from which the producing elements of the installation produce energy and/or the cost of operation and/or the environmental cost and/or weather forecasts and/or comfort parameters and/or the observed and/or expected behaviour of the users of the installation.

The modelling phase P1 of the physical installation by the multi-agent control-command system 100 also comprises a step E3 of establishing software representations 190, 195 associated with sensor elements 110 and/or actuator elements 120 of the installation. The software representation 190 associated with each sensor element 110 of the installation and the software representation 195 associated with each actuator element 120 of the installation is associated on the one hand with a history and with a forecast the values of which can be observed by the agents of the control system 100, and on the other hand with a single agent of the control system 100 responsible for updating this software representation. The agent with which the software representation 190 associated with a given sensor element 110 is associated contains a forecast model implemented by a computer configured so as to produce a forecast of the software representations 190 of the sensor elements 110 which are associated with it. In parallel, the agent with which the software representations 195 of a given actuator elements 120 is associated contains a planning model implemented by a computer configured so as to produce a planning of the software representation 195 of the actuator element 120 which are associated with it. These models can also be contained directly in the software representation of the sensors 190 or of the actuators 195.

Using this modelling in the form of multi-agent control-command system resulting from the modelling phase P1 as a basis, the phase P2 of regulation of the physical installation can be carried out as described below with reference to the steps E4 to E18 (FIG. 2). This description corresponds to a centralized implementation of the approach, that is to say the case where all the agents would be run on one and the same computer. The approach is also perfectly applicable in the case of a decentralized implementation, that is to say in the case where one or more agents would be run on different computers (an agent representing an apparatus can, for example, be transferred to a computer present on the apparatus itself). In this case, the steps specific to each type of agent would be implemented on the computer, and a communication mechanism between the agents (not described here, but existing in the literature) would be added in order to enable them to exchange the information necessary to the correct running of the system. Typically, each request involving two agents (planning request, etc.) would involve an exchange of messages between the corresponding agents.

In a first stage, prior to the optimization step E10, the regulation phase P2 comprises a step E4 of reception by the multi-agent control-command system 100 of the values originating from the sensor elements of the installation and a step E5 of initialization of the multi-agent control-command system 100 based on the values received in the reception step E4. Notably, the initialization step E5 comprises a step E6 of updating the control system 100 during which each of the agents of the control system 100 updates the forecast of the software representations 190 associated with the sensor elements 110 associated with this agent, based on the values received in the reception step E4 and based on the implementation of the forecast model by a computer. In other words, at the start of each time step in the case of optimization steps E10 carried out periodically, the instantaneous values of the sensor software representations 190 associated with the sensor elements 110 are updated with the values observed in the physical installation. Using these elements and the forecast model of the software representations 190 associated with the sensor elements 110 as a basis, all the agents of the control system 100 update the forecast of each software representation of the sensors 190 for which they are responsible.

The initialization step E5 also comprises a step E7 of determining:
forecasts of energy needs of the consuming agents 150 by implementing the model of the consuming agents 150 via a computer based on the forecasts of software representations 190, associated with the sensor elements 110,
and/or forecasts of resources and/or of the associated costs of the producing agents 140 by implementing the model of the producing agents 140 via a computer based on forecasts of the software representations 190 associated with the sensor elements 110.

The steps E6 and E7 can be carried out simultaneously or sequentially, in any mutual order. The operation can therefore be as follows: an agent, when it receives the observed value of a sensor element 110, updates the instantaneous value of the software representation 190 associated with this sensor element 110. It then immediately updates its energy need forecasts (if it is a consuming agent 150) or its energy resource forecasts (if it is a producing agent 140), without waiting for all the values of the sensors 110 to have been received by all the agents of the system. The steps E6 and E7 are then combined. In practice, the result obtained would be potentially of lesser quality in the case of sequential operation, because each agent would not necessarily use the latest observed value of the sensors 110. Nevertheless, the approach would remain functional. Furthermore, in the case of a decentralized implementation, the step E5 can advantageously be implemented in this way. This second possibility offers the advantage of greater flexibility to the system.

In other words, by using their internal model as a basis during the initialization step E5, the consuming agents 150 of the control system 100 then construct their energy need forecast making it possible to meet their objective function, and the producing agents 140 of the control system 100 construct their forecast of resources and the associated costs.

Then, the regulation phase P2 can comprise a step E8 of selecting of the optimization criteria then used during the subsequent steps of the regulation phase P2 (notably during the optimization step E10) followed by a step E9 of acquisition by the control system of the optimization criteria selected in the selection step E8. It should however be specified that these steps E8 and E9 can be carried out during the modelling phase P1, or preconfigured in the system, or even input at another time (before the step E5, for example).

The distributed hierarchical optimization step E10 carried out following the initialization step E5 comprises at least one step E11 of collecting, for each of the distributing agents of the control system, forecasts of energy needs of each of its “client” agents, based on forecasts of energy needs of the consuming agents, and on forecasts of resources of each of its energy “supplying” agents, based on forecasts of resources of the producing agents.

Remember that each distributing agent of the control system 100 is associated with at least one other agent of “supplier” type and with at least one other agent of “client” type, these “supplier” and “client” agents being producing agents or distributing agents or consuming agents depending on the position in the distribution network, which makes it possible to implement the collection steps E11. More specifically, the steps E11 of collecting forecasts of energy needs of the “client” agents and forecasts of energy resources of the “supplying” agents are advantageously repeated alternately, by successive iterations at the level of each distributing agent.

It emerges from the above that the distributed hierarchical optimization step E10, based on the distributing agents of the control system and operating iteratively, first of all makes it possible to refer and consolidate the needs of the consuming agents to the producing agents, by successive steps on each distributing agent, through its “client” agents and its “supplying” agents.

Then, starting from the producing agents, the optimization step E10 comprises an optional step E12 of adjusting the forecasts of resources of the “supplying” agents and the forecasts of energy needs of the “client” agents during which, based on the forecasts of resources available at the producing agents, the distributing agents optimize, with their “supplying” agents, the resources making it possible to meet the energy needs of their “client” agents. Then, the method comprises a mandatory step E13 during which the distributing agents select the resources based on the optimization criteria acquired in the step E9, taking into account any adjustments from the step E12.

Then, the optimization step E10 mandatorily comprises an allocation step E14 consisting in assigning (or allocating) to the “client” agents the resources selected in the step E13 and an optional step E15 of checking the satisfaction of the consuming agents and/or of the “client” agents receiving the resources assigned in the allocation step E14. Optionally, the steps E12, E13, E14 and E15 can be iterated (either altogether, or just some of them) until the satisfaction of the consuming agents and/or of the “client” agents is met.

Unlike the existing approaches, this process makes it possible to choose the criterion or criteria which will be used to perform the optimization. Thus, by using the internal models of the agents as a basis, it is possible to minimize, for example, the energy consumption and/or the cost of operation and/or the environmental cost, while observing the comfort of the occupant of the building, taken into account through the computation of the initial needs and the satisfaction of the “client” agents at each level of the control system.

The optimization step E10 finally comprises a mandatory step E16 of putting in place a planning of the resources to be received and/or to be produced by the producing, distributing and consuming agents, each planning being established on the basis of the resources assigned in the allocation step E14 and corresponding to a state of the actuator elements 120 of the physical installation 200. This corresponds to a status of the control system 100 in which the producing 140, distributing 160 and consuming 150 agents have a planning of the resources that they will receive and/or have to produce. The plannings produced in the step E16 correspond to a fixed status of all the software representations of the actuators 195 associated with the actuator elements 120 of the installation 200 for each future time step, computed using their internal model. At the end of the time step, this status is assigned to each of the software representations 195 associated with the actuator elements 120 by the agent which is responsible for them.

Thus, following the optimization step E10, the phase P2 of regulation of the installation can comprise, to physically carry out the control of the actuator elements of the installation based on the results and the forecasts from the step E10, on the one hand, a step E17 of planning the control of the actuator elements of the physical installation (this control being able to be carried out in any suitable manner), and on the other hand a step of actual control based on the control planning obtained from the step E17, for example in the form of a step E18, described later, of transmitting control commands by the control system to the actuator elements.

The status in the next time step of the software representations 195 associated with the actuator elements 120 is assigned to the physical actuators 120 of the installation, which handles the control of the system.

This is why the method can comprise a step E18 of transmission of control commands by the control system to the actuator elements, these control commands being configured so as to place each of the actuator elements in the state corresponding to the planning previously put in place in the step E16.

The invention relates also to a system for controlling an energy management installation, comprising software and/or hardware elements which implement the control method described above. Notably, in the particular case of the thermal management of a building, the control system is a system for managing the thermal systems of the building, the consuming elements being chosen for example from heating and/or ventilation and/or air conditioning and/or sanitary hot water production elements. The installation can also relate to a heat network or a system coupling thermal and electrical energy.

The invention relates also on the one hand to a computer-readable data storage medium, on which is stored a computer program comprising computer program code means for implementing the phases and/or steps of the control method, and, on the other hand, a computer program comprising a computer program code means suitable for carrying out the phases and/or steps of the control method when the program is run on a computer.

This control method makes it possible to address the following various issues.

First of all, the proposed approach makes it possible to produce an optimization on the basis of different criteria, such as, for example, the energy consumption and/or the cost of operation and/or the environmental cost (for example, the carbon footprint). In practice, the internal models of the producing and distributing agents enable them to compute the energy needs associated with their function. By coupling them with the information supplied by the environmental agents, such as forecasts of the cost of electricity and of the environmental cost, each agent can thus compute its own costs. The control system can then use this information in the optimization step E10 and prioritize the selected optimization criterion. It will moreover be noted that the environmental agents make the approach greatly extendable. For example, the dynamic variation of the prices of electricity will soon emerge following the wide scale deployment of communicating meters. This variation can easily be incorporated through the environmental agents, without modifying the approach or the operation of the control system.

Then, the approach makes it possible to take into account the specifics of new energy sources. In practice, in some cases, there is a coupling between the apparatuses producing thermal energy and the modalities according to which this energy is distributed. Such is for example the case for the air/water or air/air heat pumps, the efficiency of which depends on the flow of air passing through them. The solution according to the invention explicitly describes the energy distribution network, and incorporates an internal model for each of the elements modelling a sub-part of this network. The distributing agents can thus optimize their own operation in coordination with the producing agents.

This explicit representation of the distribution network also makes it possible to take into account the specifics linked to the aeraulic or hydraulic transport vectors. In particular, the agents representing this network incorporate in their internal model a modelling of the operation of the auxiliaries which convey the energy through the physical installation. These auxiliaries induce additional needs (because of electrical consumption for example) and resources (because of losses in the form of heat for example). The optimization process thus makes it possible to incorporate these elements in the regulation of the installation.

Finally, the proposed solution increases the reusability of the systems designed. In practice, each apparatus of the installation is represented by an agent, which is an autonomous entity that meets precise specifications. Thus, the replacement of one agent with another has no influence on the operation of the control system. Furthermore, agents representing similar entities (for example two heat pumps of different makes) will differ only through the parameterizing of their internal model, which makes them easy to reuse between different installations.

The main (but nonlimiting) application studied is the management of the thermal systems for the building. The solution according to the invention is particularly suited to the context of the regulation of apparatuses ensuring heating and/or cooling and/or ventilation and/or sanitary hot water production functions, these apparatuses often being dedicated to low energy consumption buildings. However, more generally, the solution according to the invention is applicable to any installation managing energy. It can take into account any type of energy production (wood or gas boilers, for example). Furthermore, beyond the management of the thermal installations for the building, it can also incorporate the electrical dimension (for example, photovoltaic solar panels and electric convectors). The proposed solution can also be physically distributed between the different apparatuses, which does not restrict it to fully integrated apparatuses or to the use of a centralized controller. Furthermore, it is extendible: sophisticated models for forecasting consumption, for forecasting the behaviour of the inhabitants or the sanitary hot water consumption can be included therein.

Finally, the solution has been designed to be able to be applied to other fields. Through the modelling of the plants by producing agents, the buildings by consuming agents and the water distribution network by distributing agents, it is possible for example to model and control a heat network, on a district-wide or town-wide scale. Through the modelling of the plants by producing agents, the buildings by consuming agents, and the electrical network by distributing agents, it is possible for example to model and control an intelligent electrical network, or “smart grid”.

Subsequently, an exemplary physical installation application will be described, which will serve as a support for the description of the application of the control method. The multi-agent control system will then be described and used in order to model the physical installation, before specifying the operation of the regulation based on this multi-agent control system. Finally, the implementation of the solution according to the invention will be detailed on the exemplary installation presented.

The application context is the management of the thermal systems for the building. In the case of low energy consumption buildings, called “BBC” buildings, whose energy needs are low, the manufacturers have developed dedicated ranges of apparatuses or installations. These make it possible to ensure, with a single equipment item, a number of functions in the building, such as the heating and/or the cooling and/or the ventilation and/or the sanitary hot water production. These apparatuses, described as multifunction apparatuses, generally combine different elements such as:
dual flow exchanger, allowing for an exchange of heat between the extracted air and the air intake, for example in order to preheat the fresh air entering into the building by using the hot air extracted therefrom in winter periods,
a heat pump, partly ensuring the heating needs of the sanitary hot water tank and/or of the building,
and a sanitary hot water tank, the heating of which can be complemented by electrical input or thermal solar panels.

Because of the low heating powers involved, the heating vector of the building is generally air in order to offer a simple and compact physical installation: the heating infrastructure is in fact then common with the ventilation infrastructure. The installation is instrumented using different sensors, which supply information making it possible to observe its status over time.

The control method described previously can thus, for example, be applied to the design of the regulation of such multifunction apparatuses. Subsequently, the implementation of the control method will be described in relation to an apparatus making it possible to ensure the sanitary hot water production and/or ventilation and/or heating and/or cooling functions. Such an apparatus can, for example, notably combine, with reference to FIG. 4, the following elements:
a dual-flow exchanger 10, providing a heat exchange between an air intake running from a new air zone 11 to an incoming air zone 12 in the building and an extracted flow running from a polluted air zone 13 to an outgoing air zone 14 outside the building,
a three-zone tank 18 for sanitary hot water 19, provided with a top-up electrical element 16 in the top zone,
a heat pump 15 ensuring the heating 20 of the central part of the tank 18,
and thermal solar panels 17 ensuring a heating function in the bottom part of the tank 18.

The sanitary hot water production 19 is ensured by the three-zone tank 18. The bottom zone of the tank 18 is heated by the thermal solar panels 17, the central zone of the tank 18 is heated by the heat pump 15, and the top zone is heated by the top-up electrical element 16.

The heating function of the building is ensured by the combination of the dual-flow regenerator 10 and an exchanger 21 between the central part of the tank 18 and the incoming flow of air. The heat pump 15 therefore simultaneously ensures a heating function and a sanitary hot water production function. The flow of air through these apparatuses is ensured by fans which are not represented.

In order to allow for the control of the installation by the control system corresponding to the invention, the physical installation is first of all modelled in the form of a multi-agent control system 100, the features of which are presented in FIG. 4.

First of all, the multi-agent control system 100 has an internal representation of the time and knows the period of time separating two time steps, which enables it to manipulate the time-related concepts. These two elements enable it to construct forecasts over a defined anticipation period, called forecast horizon. A history of parameterizable length is also defined.

A set of devices 180 incorporated in the control system 100 makes it possible to provide the interface between the physical system (corresponding to the physical installation) and its modelling in the form of a multi-agent control system 100, and provide additional information. A device 180 is a structure intended to represent software information. This information will, for example, be able to be associated with a physical sensor 110 or actuator 120, a cost, or even a virtual sensor. A device 180 contains in particular a forecast of its values to the forecast horizon, and a history. For example, if the aim is to represent in the system 100 the instantaneous cost of the electricity originating from the network, and associate with it a forecast to the time horizon and a history, a device 180 is then defined which makes it possible to represent such information.

Out of all the devices 180, two particular types are differentiated: the set of sensor software representations 190 associated with the sensor elements 110 and the set of actuator software representations 195. A sensor software representation 190 is the software representation of a physical sensor 110. An actuator software representation 195 is the software representation of a physical actuator 120. The sensor 190 and actuator 195 software representations make it possible to provide the interface between the control-command and the physical installation 200.

For example, if the physical system 200 is equipped with a physical sensor element 110 measuring the internal temperature of the building, this sensor element 110 can be associated with a sensor software representation 190 which makes it possible to represent, in the multi-agent system 100, the current value of the physical sensor 110 and associate with it a forecast and a history.

For example, if the physical system 200 is equipped with an actuator element 120 making it possible to control the starting and the stopping of an apparatus, this actuator element 120 can be associated with an actuator software representation 195 which enables the multi-agent system 100 to compute an update of its status, a planning of its future states and retain a history of its values.

The multi-agent control system 100 comprises four types of virtual agents: producing agents 140, consuming agents 150, distributing agents 160 and environmental agents 170.

A producing agent 140 is an agent whose function is to transform energy into thermal energy. It contains an internal model implemented by a computer, which enables it in particular to compute, for a given duration, the thermal energy resources that it can produce, and the energy consumed for this production. A producing agent also contains a set of devices 180 associated with an internal model. Among these devices 180 there may be sensor software representations 190 and actuator software representations 195.

For example, an electrical element can be modelled by a producing agent 140. Its internal model can describe the thermal energy supplied and the energy consumed (here electrical energy) for example as follows:

E_{produced}=E_{consumed}=Pₘₐₓ*Δt

with Pₘₐₓ being the maximum power of the element and Δt the duration of operation. The element can be associated with the actuator software representation 195 controlling its starting and stopping. The internal model of this actuator software representation 195 can be based on a planning of production: the element is active if a production is necessary and is inactive otherwise.

A consuming agent 150 is an agent whose function is to ensure the comfort of the occupant by using thermal energy. A consuming agent 150 is associated with an objective function. Typically, this function can be a setpoint 210, possibly multiple (heating and cooling setpoints in a building, for example). A consuming agent 150 also contains a utility function. This can be a simple function, for example taking into account the observance or non-observance of the objective, or an advanced function, incorporating for example concepts of amplification of discomfort over time. The utility can also be used to define a priority between the different consumers of the system. A consuming agent 150 also contains an internal model enabling it in particular to compute its energy needs in order to satisfy its objective function. Finally, it contains a set of devices 180 associated with an internal model. Among these devices 180 there can be sensor software representations 190, but no actuator software representation 195.

For example, the thermal comfort can be modelled by a consuming agent 150. Its objective function can be to reach a constant setpoint 210 at 19 degrees Celsius and its internal model can be a thermal model of the building making it possible to determine the energy needed to reach the setpoint 210, such as, for example, according to the following description:

E_{necessary}=CAP*(T_{cons}−Tᵢₙₜ)+UA*(3/2*Tᵢₙₜ−T_{cons}/2−Tₑₓₜ)*Δt

with UA, CAP being characteristic constants of the building.

A distributing agent 160 is an agent whose function is to influence the transfer of the thermal energy in the building. A distributing agent 160 models a sub-part of the distribution network 220 of the physical system 200: the set of distributing agents 160 makes it possible to represent the network of hydraulic or aeraulic connections between the apparatuses 230 of the physical system 200. A distributing agent 160 contains an internal model, which makes it possible to model the constraints and the costs linked to the routing of the energy. These can be the losses linked to the network and/or the cost of operation of a fan making it possible to ensure a flow of air between different apparatuses 230. A distributing agent 160 contains a set of “client” agents, which can be either consuming agents 150, or other distributing agents 160. It also contains a set of “supplying” agents, which can be either producing agents 140, or other distributing agents 160. By definition, a producing agent 140 can be a “supplying” agent only of a single “distributing” agent, and a consuming agent 150 can be a “client” agent only of a single distributing agent 160. By contrast, a distributing agent 160 can be a “client” agent or a “supplying” agent of any number of other distributing agents 160. This definition leads to a hierarchical description of the control system 100. Finally, a distributing agent 160 contains a set of devices 180 associated with an internal model. Among these devices 180 there can be sensor software representations 190 and actuator software representations 195, the updating of which is its responsibility.

For example, the fluid circuit between a thermal solar sensor 17 and a tank 18 can be modelled by a distributing agent 160. This agent 160 will have a “supplying” agent (the solar sensor) and a “client” agent (the tank). It is associated with an actuator 120 consisting of the circulator making it possible to move the fluid in the circuit. The internal model of this circulator can be based on a planning of production: it will be on if production is necessary and off otherwise. Finally, the internal model of the agent 160 can, for example, incorporate the cost linked to this distribution because of the consumption of the circulator, and computed for example as follows:

E_{consumed}=Pₘₐₓ*γ*Δt

with Pₘₐₓ being the maximum power of the circulator, γ the control signal between 0 and 1 and Δt the duration of operation.

An environmental agent 170 makes it possible to add additional information concerning the real environment of the physical system 200 by modelling some of its externals. This information is represented in the form of a set of devices 180 associated with an internal model. Among these devices 180 there can be sensor software representations 190, but no actuator software representation 195.

For example, the financial cost of the electrical energy originating from the network can be managed by an environmental agent 170. This agent then ensures the updating of a device representing this cost, by using an internal model representing, for example, the peak and off-peak hours, or dynamic variations of the price of the electricity 240. An environmental agent 170 can also incorporate a model associated with information concerning weather conditions 250 for example.

Moreover, each device 180 can be updated only by a single agent of the control system 100.

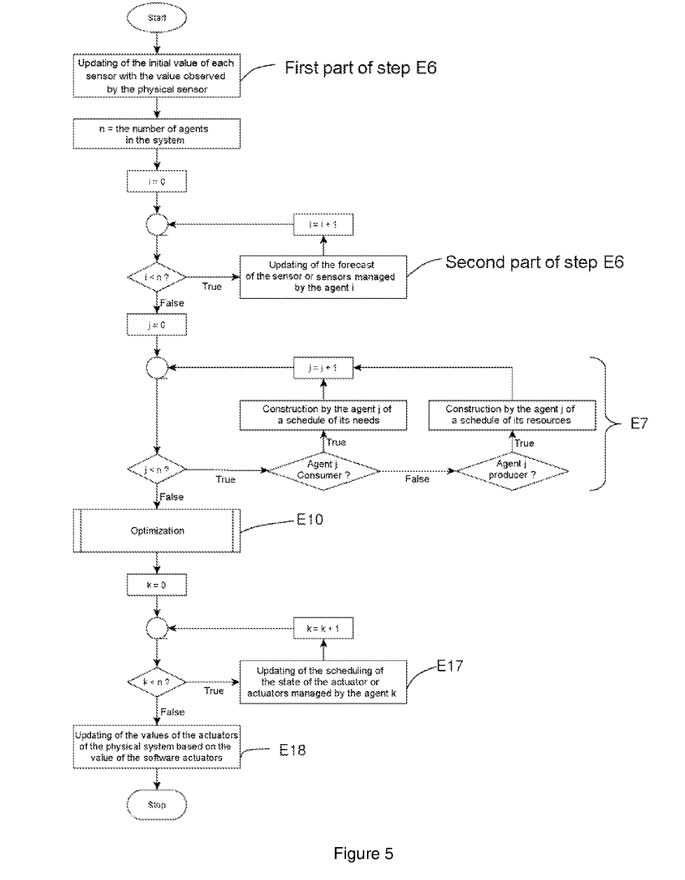

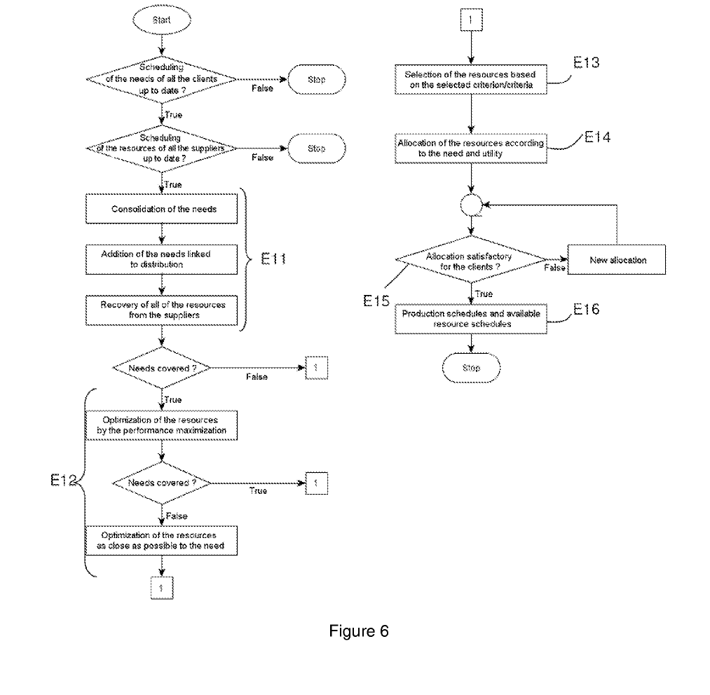

This description of the physical installation in the form of a multi-agent control system 100 then allows for automated operation of the regulation. This operation relies on a distributed hierarchical optimization. The main control loop is described first below with reference to FIG. 5 before detailing the optimization step itself with reference to FIG. 6.

FIG. 5 shows an exemplary algorithm making it possible to provide this operation for a centralized version of the regulation.

The main control loop of FIG. 5 manages all the operations initiated at each time step and makes it possible to ensure the regulation of the physical installation. It runs in accordance with the control method described in FIG. 2 introduced previously. In a distributed architecture, this loop is distributed over the different available computation means, which correspond to subsets of the system 100. The start of a time step is marked by the reception of the information from the physical installation, corresponding to the reception step E4.

The first action of the multi-agent system 100 is then to update (first part of the updating step E6) the initial value of the forecast of each of the sensor software representations 190 using the physical value measured by the associated physical sensor element 110. Then, each agent of the system 100 computes the forecast of the future values of each sensor software representation 190 for which it is responsible, by using the internal forecast model associated with this sensor software representation 190 (which corresponds to the second part of the updating step E6). This operation is repeated for all the agents of index i.

The initial plannings of the needs of the consuming agents 150 and the initial plannings of resources for the producing agents 140 are then constructed (which corresponds to the determination step E7):
each consuming agent 150 constructs a forecast describing its energy needs to the time horizon. This forecast is constructed using the internal model of the agent 150, its objective function and its utility function.
Each producing agent 140 constructs a forecast describing the resources that it can supply to the time horizon and the energy which will be consumed for this production. This forecast is constructed using the internal model of the agent 140. By using additional devices 180 as a basis, indicating for example the costs associated with the energy in question, it is then possible to optionally incorporate in this forecast the financial cost associated with the production, and/or the environmental cost, and/or performance coefficients regarding these quantities, and/or other criteria. It should be noted that each producing agent 140 also contains a production planning, which describes the planning of its production to the time horizon.

These operations are repeated for all the agents of index j (j varying from 0 to n).

Then, a distributed hierarchical optimization is carried out (corresponding to the optimization step E10), based on the distributing agents 160, and detailed in the next section. It makes it possible to construct, for all the producing 140, distributing 160 and consuming 150 agents, a planning of the resources that they will receive and/or that they have to supply by taking into account optimization criteria previously selected in the step E8 and acquired during the step E9. Any optimization method that makes it possible to construct these plannings with the requisite properties could be suitable here. A method is proposed and detailed in relation to FIG. 6 and the adjustment of the resources (adjustment step E12), the selection of the resources according to the chosen criteria (selection step E13), then the allocation (allocation step E14) of these resources to the “client” agents and the checking (checking step E15) of their satisfaction. The plannings obtained correspond to a determined status of all the actuator software representations 195 of the system 100 to the time horizon. Based on these plannings, each agent updates the next value and the forecasts of each actuator software representation 195 for which it is responsible. This corresponds to the placement step E17. These operations are repeated for all the agents of the system, the index k varying from 0 to n.

Finally, the status of the actuator software representations 195 at the next time step (corresponding to the control planned by the agents) is sent to the physical actuators 120, which produces an update of the physical actuators 120 and control of the installation 200. This corresponds to the transmission step E18.

Now referring to FIG. 6, the distributed hierarchical optimization step E10 is based on the distributing agents 160. Each distributing agent 160 waits to see if the prerequisites for its next internal step are not fulfilled. These prerequisites are of two types:
in the consolidation E11 of the needs, the planning of the needs of all its “client” agents must be up-to-date,
in the optimization E12 of the resources, the planning of the resources of all its “supplying” agents must be up-to-date.

Each distributing agent 160 performs the following internal steps.

First of all, the distributing agent 160 recovers, from its “client” agents, the planning for their needs. When all the plannings are up-to-date, it updates its own planning of needs. This update can, for example, be done by consolidating the needs of all its “client” agents and associating a utility with them. This consolidation (symbolized by the first rectangle in the left hand flow diagram) can, for example, be done by summing the needs of the “client” agents, by adding to them the additional need associated with the distribution (step symbolized by the second rectangle in the left hand flow diagram) computed using the internal model of the distributing agent 160. This additional need makes it possible for example to incorporate head or heat losses on the distribution network. Moreover, the utility associated with each of the needs can, for example, be the maximum of the utilities of the “client” agents that have a need in this time step. This planning is then available to the “supplying” agents for which the distributing agent 160 is itself a “client” agent. Globally, the implementation of these principles makes it possible to carry out a part of the collection step E11 described in FIG. 2.

In the same way, the distributing agent 160 recovers from its “supplying” agents the planning of their resources. Globally, the implementation of these principles makes it possible to carry out another part of the collection step E11 described in FIG. 2. When all the plannings are up-to-date, the distributing agent 160 goes on to the next steps below.

A possible adjustment step E12 then takes place to perform an optimization (symbolized by the fourth and fifth rectangles in the left hand flow diagram). Then, a step E13 of selection (symbolized by the first rectangle in the right hand flow diagram) of the resources based on the selected criteria is mandatorily completed, as is a step E14 of allocation (symbolized by the second rectangle in the right hand flow diagram of FIG. 6) of the resources to the clients and finally, optionally, a step E15 of checking (symbolized by the rhomboid in the right hand flow diagram of FIG. 6) their satisfaction.

During the optimization and resource selection phase, the aim is to select, from the resources available with the “supplying” agents, the resources that minimize the optimization criteria chosen during the step E8. The total of the resources selected should furthermore meet a comfort demand. The process runs as follows:

First of all, from the initial set of resources, the system 100 checks (phase symbolized by the third rhomboid in the left hand flow diagram of FIG. 6) whether the need is covered. If it is not covered, the system 100 goes on to the phase E13 of selection of the resources. If it is covered, the system 100 goes on to the step of optimizing the resources by maximizing the performance (step symbolized by the fourth rectangle in the left hand flow diagram of FIG. 6): the distributing agent 160 and its “supplying” agents optimize all the resources, in order to obtain a set that maximizes the performance corresponding to their combined operation. This step makes it possible to take into account the influence of the energy distribution modalities on the production of said energy.

If the set of resources that is thus obtained covers the need, the system 100 goes on to the resource selection phase E13. Otherwise, if the set of resources does not cover the need, the system 100 goes on to the step of optimizing the resources as closely as possible to the need of the installation 200 (step symbolized by the fifth rectangle in the left hand flow diagram of FIG. 6). A number of strategies are possible. For example, by starting from the previously determined set of resources, the system 100 can adapt the quantity supplied to the need, until the need is covered. Another possibility is to maximize the performance coefficient of each available resource, until the set of resources satisfies the need. At the end of this step, the distributing agent 160 has a planning containing all the selected resources.

Then, referring to the right hand flow diagram of FIG. 6, the system 100 performs a selection E13 of the resources, an allocation E14 of the resources and a check E15 on satisfaction. Thus, in a first selection phase E13 (step symbolized by the first rectangle in the right hand flow diagram of FIG. 6), the system selects from the resources those that maximize the chosen criterion or criteria. This selection can be done using different objective functions. For example, the chosen function can be a combination of different criteria, such as the financial cost and the environmental cost:

u=a*c_{financial}+b*cₑₙᵥᵢᵣₒₙₘₑₙₜₐₗ

with a and b being constants chosen as a function of a particular affinity of the user.

The objective can also be to give priority to selecting the resources according to certain criteria: for example, first select the resources for which the financial cost is lowest, then, given equal cost, those for which the environmental cost is lowest. For this type of selection the use of a performance coefficient is particularly advantageous because it reflects the energy efficiency as a function of cost (financial, environmental, etc.). These criteria can be parameterized by the occupant through the interface of the system 100.

In a second phase E14 of allocation (symbolized by the second rectangle in the right hand flow diagram of FIG. 6) of the resources to the clients, an allocation of resources according to the need and the utility is performed. The resources are allocated according to the energy need and the utility that each “client” agent associates with it. For this, the distributing agent uses a utility function, defined as follows: for each “client” agent, if, at the instant t, this “client” agent has a non-zero energy need, then the utility for the resource is equal to the utility of this “client” agent. This allocation E14 makes it possible to construct the production planning of each “supplying” agent of the distributing agent 160, and the resource planning of each of its “client” agents. During this step, the distributing agent 160 deducts, from the available resources, its own needs that it had added during the step of consolidating the needs in the left hand flow diagram.

Finally, the satisfaction associated with the allocation made is checked during the step E15 (symbolized by the rhomboid in the right hand flow diagram of FIG. 6) for each of the “client” agents. If the allocation satisfies all of them, it is retained. Otherwise, the allocation E14 and the check E15 are iterated (new allocation symbolized by the second rectangle of the right hand flow diagram of FIG. 6) in order to maximize the satisfaction of the “client” agents.

Finally, the decisions taken are then available for the “client” agents and the “supplying” agents of the distributor agent (step symbolized by the third rectangle of the right hand flow diagram of FIG. 6). The latter are available for each of the “supplying” agents in the form of a production planning, and for each of the “client” agents in the form of a resource planning.

When all of the distributing agents 160 have been executed, each of the producing agents 140 and each of the distributing agents 160 has an up-to-date production planning.

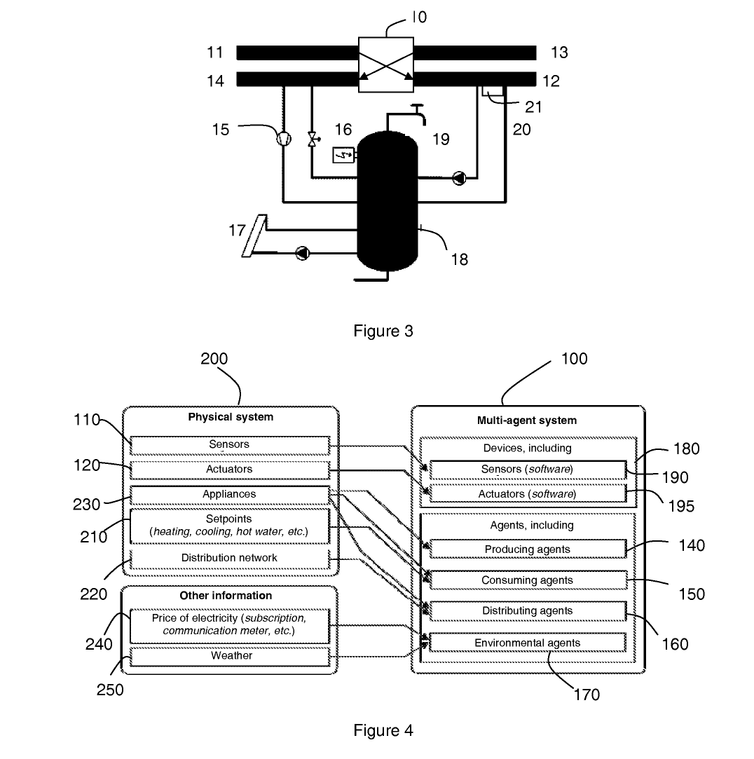

The application of the above method to the particular example of the multifunction apparatus of FIG. 3 is now described. The aim here is to carry out the regulation of the multifunction apparatus, which ensures ventilation and/or cooling and/or sanitary hot water production functions. The modelling of the system 100 in the form of agents is presented below before going on to detail the specifications of each of the agents. Once this modelling has been done, the proposed system 100 makes it possible to ensure the regulation in an automated manner.

The physical system 200, that is to say the energy-managing installation consisting of the multifunction apparatus, is made up of a set of sensor elements 110, actuator elements 120, and different apparatuses 230. It is instrumented by different sensors 110, detailed in the table below. Each of these sensor elements has a sensor software representation 190 associated with it.

| Sensor | Description |
|---|---|
| Tₜₐₙₖ_{_{—}}_{T} | Tank temperature, top part |
| Tₜₐₙₖ_{_{—}}_{M} | Tank temperature, middle part |
| Tₜₐₙₖ_{_{—}}_{B} | Tank temperature, bottom part |
| Tₛₑₙₛₒᵣ | Solar sensor temperature |
| Tₑₓₜ | Outdoor temperature |
| Tᵢₙₜ | Indoor temperature |
| T_{polluted}_{_{—}}ₐᵢᵣ | Temperature of extracted air after passing through the |
| | dual-flow exchanger |
| T_{new}_{_{—}}ₐᵢᵣ | Temperature of new air after passing through the dual-flow |
| | exchanger |

Actuators make it possible to control the apparatuses 230 and the distribution elements, such as the circulators and the fans (detailed in the table below). Each of these actuator elements 120 has an actuator software representation 195 associated with it.

| Actuator | Description | Possible values |
|---|---|---|
| Ctrlₕₚ | Heat pump | {0, 1} (off, on) |
| Ctrlₛₒₗ_{_{—}}_{circ} | Solar circulator | [0, 1] |
| Ctrlᵣₑₛ | Electrical element | {0, 1} (off, on) |
| Ctrl_{fan} | Fan | [0, 1] |
| Ctrlₕₑₐₜ_{_{—}}_{circ} | Heating circulator | [0, 1] |

The apparatuses are the dual-flow exchanger 10, the sanitary hot water tank 18, the heat pump 15, the thermal solar panel 17 and the top-up electrical element 16 for the tank 18. The functions handled are ventilation and/or heating and/or cooling and/or sanitary hot water production. The last three of these functions are associated with comfort objectives embodied in the form of setpoints 210.

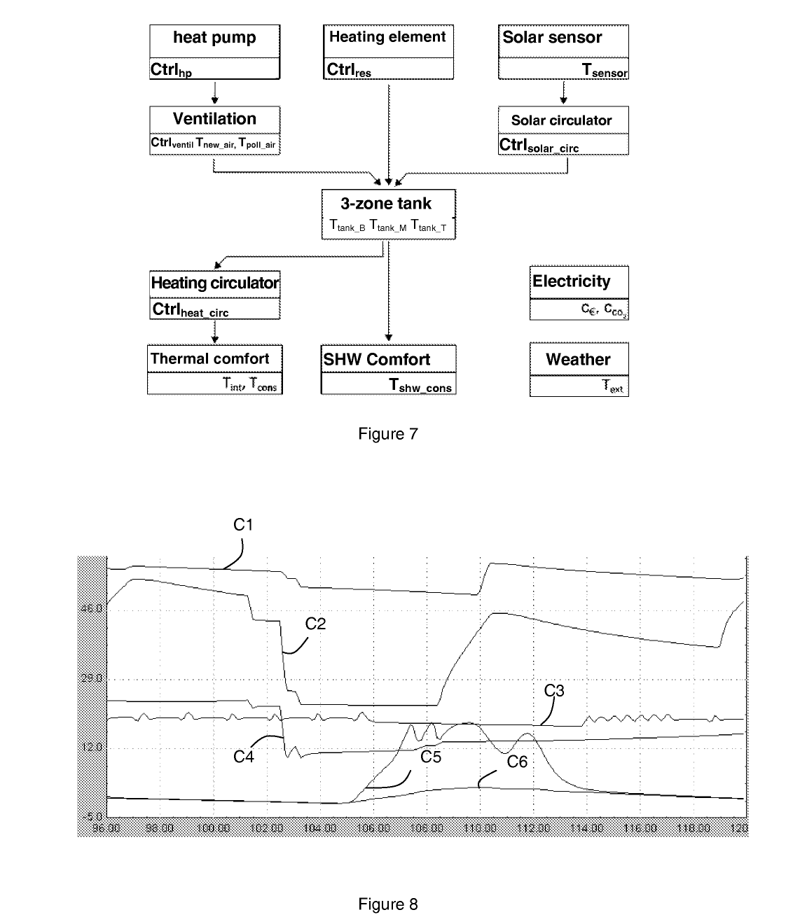

The different elements of the installation are modelled as follows, with reference to FIG. 7:
the producing agents 140 are the heat pump 15 “HP”, the thermal solar panel 17 “solar sensor” and the top-up electrical element 16 identified as “heating element”,
the consuming agents 150 correspond to the “thermal comfort”, embodied by the building 130, and to the sanitary hot water comfort (identified as “SHW comfort”).

Next, different distributing agents 160 are differentiated and model the energy transport network:
an agent called “ventilation” models the ventilation circuit, incorporating the fans and the dual-flow exchanger 10,
a “solar circulator” agent models the hydraulic network between the solar panel 17 and the tank 18, incorporating a circulator,
a “3-zone tank” agent models the three-zone tank 18,
and an agent called “heat. circulator” models the exchange network between the central zone of the tank 18 and the air entering into the home, incorporating a circulator.

Finally, two environmental agents 170 make it possible to incorporate the externals of the system:
the first called “weather” provides the forecast corresponding to the outdoor temperature sensor. It can be considered as a weather forecast agent,
the second called “electricity” provides the forecast corresponding to the financial cost and to the environmental cost of the electrical energy originating from the grid. It can be considered as a grid agent.

FIG. 7 gives the name of the actuator or sensor element (or its software representation) associated with each agent, these names being listed in the above two tables in the left hand column.

The agents represented in FIG. 7 incorporated in the control-command system 100 established in relation to the installation of FIG. 3 are detailed below.

The heat pump 15 is modelled by a producing agent 140 called “heat pump”. It is associated with the actuator software representation 195 corresponding to the physical actuator used to switch it on and off (Ctrlₕₚ). Since the heat pump 15 can be controlled only by switching it on or off, the internal model of this actuator software representation 195 corresponds to a switching-on if energy has to be produced in the corresponding time step and to a switching-off otherwise. The internal model of the “heat pump” agent can, for example, include a parameter for varying efficiency as a function of ventilation:

E_{produced}=(a*Tₚₒₗₗ_{_{—}}ₐᵢᵣ+bTₚₒₗₗ_{_{—}}ₐᵢᵣ+c*T_{new}_{_{—}}ₐᵢᵣ+d)*Δt*f(q)

with a, b, c, d being constants characteristic of the heat pump 15, Δt the duration of operation, and f(q) a function of the air flow rate passing through the exchanger 10.

This model makes it possible to estimate the energy supplied by the heat pump 15 and to compute the trade-off between ventilation and heating power. The energy finally consumed can, for example, correspond to the power of the compressor of the heat pump 15, computed as follows:

E_{consumed}=P_{compressor}*Δt

This model makes it possible to compute the thermal energy produced and the energy consumed, here the electrical energy originating from the grid. More complex models, based for example on the interpolation of real operating points, can also be used.

The solar panel 17 is modelled in the system 100 by a “producing” agent called “solar sensor”. It is associated with the sensor corresponding to its temperature (Tₛₑₙₛₒᵣ). The internal model used for its forecast can, for example, be the value adjusted from the day before:

Tₛₑₙₛₒᵣ(t_{final})=Tₛₑₙₛₒᵣ(t_{final}−24 h)+(Tₛₑₙₛₒᵣ(tᵢₙᵢₜᵢₐₗ)Tₛₑₙₛₒᵣ(tᵢₙᵢₜᵢₐₗ−24 h))

with t_{final} being the final instant and tᵢₙᵢₜᵢₐₗ being the initial instant for the forecast.

With regard to the internal model of the solar panel 17, according to the recommendations of the standard NF-EN-12975-2, the following formula can for example be used:

E_{produced}=η*S*G*Δt

with η=η₀−a₁*(Tₘ−Tₐ)/G−a₂*(Tₘ−Tₐ)²/G
with S being the surface area of the solar sensor, G the insulation, Δt the duration, η₀ the optical factor, a₁ and a₂ the loss coefficients, Tₘ the mean temperature of the sensor, and Tₐ the outdoor temperature.

The panel 17 uses solar energy, its energy cost is zero. Therefore E_{consumed}=0

The electrical element 16 is modelled by a “producing” agent called “heating element”. It contains the actuator software representation 195 corresponding to its switching on and switching off. The internal model of this actuator representation 195 corresponds to a switching-on if energy has to be produced in the corresponding time step and to a switching-off otherwise. The internal model of the heating element corresponds to its electrical power: in operation, it produces its maximum thermal energy power, and consumes the equivalent in terms of electrical energy:

E_{produced}=E_{consumed}=Pₘₐₓ*Δt

with Pₘₐₓ being the maximum power of the heating element 16, and Δt the duration of operation.

The thermal comfort is modelled by a consuming agent 150 called “thermal comfort” and embodied by the thermal zone of the building 130. This agent 150 is associated with a sensor software representation 190 corresponding to the indoor temperature of the building Tᵢₙₜ. The internal model of this sensor representation 190 can for example be based on a model of the building:

Tᵢₙₜ(t_{final})=(CAP+UA*Δt*(Tₑₓₜ(tᵢₙᵢₜᵢₐₗ)−3/2*Tint(tᵢₙᵢₜᵢₐₗ))/(CAP−UA*Δt)

with UA being the coefficient of thermal losses of the building, and CAP the heat capacity of the building 130.

The objective function corresponds to the setpoints supplied by the occupant. For example, the heating setpoint can be a planning setpoint corresponding to the recommendations of the standard RT2005: setpoint temperature of 19 degrees between 6 pm and 10 am during the week, 16 degrees for the remainder of the time in the week, and set at 19 degrees over the weekend. The utility function can be associated with a relative priority between the sanitary hot water and heating needs, which compete for the use of the resources of the heat pump 15.

Finally, the internal model of the agent can be based on the thermal model of the building 130:

E_{necessary}=CAP*(T_{cons}+Tᵢₙₜ)+UA*(3/2*Tᵢₙₜ−T_{cons}/2−Tₑₓₜ)*Δt

with UA being the coefficient of heat losses of the building, CAP the heat capacity of the building, T_{cons} the setpoint indoor temperature, Tᵢₙₜ the indoor temperature and Tₑₓₜ the outdoor temperature.

The sanitary hot water comfort is modelled by a consuming agent 150 called “SHW comfort”. Its objective function can for example correspond to a setpoint T_{cons}_{_{—}}_{shw} making it possible to address the need of the occupant at any instant (constant at 50° C. for example). The internal model of the agent 150 can for example correspond to an instantaneous response to the need, based on the temperature in the top zone of the tank 18: if the latter is no longer observed, a demand for energy proportional to the difference is sent. For example:

E_{necessary}=k₁*(T_{cons}_{_{—}}_{shw}−Tₜₐₙₖ_{_{—}}_{T})

with k₁ being a characteristic constant of the installation.

Another type of internal model can use the history of sanitary hot water consumption in order to forecast the associated energy needs. The utility function of the agent 150 can for example be used in order to manage the relative priority between the heating and the sanitary hot water production.

Moreover, the distributing agents 160 model the energy distribution network within the installation.

The ventilation circuit, incorporating the fans and the dual-flow exchanger 10, is modelled by a “distributing” agent 160 called “ventilation”. It is connected to a “supplying” agent, the “HP” agent, and to a “client” agent, the “3-zone tank” agent described below. It is associated with two sensor software representations 190 corresponding to the output temperatures of the dual-flow exchanger 10, Tₚₒₗₗ_{_{—}}ₐᵢᵣ and T_{new}_{_{—}}ₐᵢᵣ. The internal models of these sensor representations 190 correspond to the characteristics of the exchanger 10, and can for example be computed as follows:

Tₚₒₗₗ_{_{—}}ₐᵢᵣ=Tᵢₙₜ−r₁*(Tᵢₙₜ−Tₑₓₜ)

T_{new}_{_{—}}ₐᵢᵣ=Tₑₓₜ+r₁*(Tᵢₙₜ−Tₑₓₜ)

with r₁ being the efficiency of the dual-flow exchanger 10.

Moreover, the “ventilation” agent is associated with the actuator software representation 195 that can be used to control the fans (Ctrl_{fan}). The internal model associated with this actuator representation 195 makes it possible to obtain the following behaviour: by default, the ventilation is at a minimum, otherwise, the value used is that obtained after optimization with its “supplying” agent, that is to say the “HP” agent modelling the heat pump 15. Moreover, the internal model of the “ventilation” agent makes it possible to incorporate the cost associated with the ventilation. This cost is added during the resource selection step E13, in order to take into account the overall cost of a resource, including its routing. For the fans, the model can for example be as follows:

E_{consumed}=Pₘₐₓ*(a₀+a₁*γ+a₂*γ²)*Δt

with a₀, a₁, a₂ being characteristic constants of the fan, γ being the control signal between 0 and 1, Pₘₐₓ being the maximum power of the fan and Δt being the operating time.

The solar circuit of the installation, which makes it possible to circulate a fluid between the solar sensor 17 and the tank 18, is modelled by a “distributing” agent 160 called “solar circulator”. It is connected to a “client” agent, the “solar sensor” agent modelling the solar sensor 17, and to a “supplying” agent, the “3-zone tank” agent modelling the three-zone tank 18. The “solar circulator” agent incorporates the actuator software representation 195 corresponding to the control of the circulator associated with this circuit. The internal model of this actuator representation 195 can, for example, correspond to a variable speed drive, in order to obtain a regulated speed so that the temperature difference between the bottom zone of the tank 18 (Tₜₐₙₖ_{_{—}}_{B}) and the temperature of the solar sensor 17 (Tₛₑₙₛₒᵣ) is constant. The internal model of the “solar sensor” agent can for example make it possible to incorporate the cost linked to its operation:

E_{consumed}=Pₘₐₓ*γ*Δt

with Pₘₐₓ being the maximum power of the circulator, γ the control signal between 0 and 1 and Δt the on time.

The heating circuit of the installation of FIG. 3 makes it possible to exchange heat between the central part of the three-zone tank 18 and the air 12 entering into the building 130, and is modelled by a distributing agent 160 called “heat. circulator”. It is connected to a “client” agent, i.e. the “thermal comfort” agent modelling the thermal comfort of the building 130, and to a “supplying” agent, i.e. the “3-zone tank” agent modelling the three-zone tank 18. The “heat. circulator” agent incorporates the actuator software representation 195 corresponding to the circulator making it possible to produce this exchange. The internal model of the “heat. circulator” agent can for example make it possible to incorporate the cost linked to its operation:

E_{consumed}=Pₘₐₓ*γ*Δt

with Pₘₐₓ being the maximum power of the circulator, γ the control signal between 0 and 1 and Δt the duration of operation.

The three-zone tank 18, for its part, is modelled by a distributing agent 160 called “3-zone tank”. This agent is connected to two “client” agents, the “heat. circulator” agent modelling the heating circuit and the “SHW comfort” agent modelling the sanitary hot water comfort, and to three “supplying” agents, namely the “ventilation” agent modelling the ventilation, the “heating element” agent modelling the heating element and the “solar circulator” agent modelling the solar circuit. The “3-zone tank” agent incorporates the three sensor software representations 190 corresponding to the temperature measurements in the bottom, middle and top zones of the tank (respectively Tₜₐₙₖ_{_{—}}_{B}, Tₜₐₙₖ_{_{—}}_{M} and Tₜₐₙₖ_{_{—}}_{T}). The internal model of these sensor software representations 190 can for example be a persistence model:

Tₜₐₙₖ_{_{—}}_{B}(t_{final})=Tₜₐₙₖ_{_{—}}_{B}(tᵢₙᵢₜᵢₐₗ) Tₜₐₙₖ_{_{—}}_{M}(t_{final})=Tₜₐₙₖ_{_{—}}_{M}(tᵢₙᵢₜᵢₐₗ) Tₜₐₙₖ_{_{—}}_{T}(t_{final})=Tₜₐₙₖ_{_{—}}_{T}(tᵢₙᵢₜᵢₐₗ)

The internal model of the “3-zone tank” agent can for example be the model proposed in the standard RT2012.

Finally, the environmental agents 170 correspond to a weather forecast agent called “weather” and to an electrical grid agent called “electricity”.

The weather forecast environmental agent 170 called “weather” is associated with the sensor software representation 190 corresponding to the outdoor temperature Tₑₓₜ. Different internal models can be used to produce a forecast for this sensor representation 190, like the persistence of the observed temperature, the use of the temperature of the previous day readjusted to that of the day, even more advanced models. For example, a model based on the readjusted value of the day before can be used:

Tₑₓₜ(t_{final})=Tₑₓₜ(t_{final}−24 h)+(Tₑₓₜ(tᵢₙᵢₜᵢₐₗ)−Tₑₓₜ(tᵢₙᵢₜᵢₐₗ−24 h))

The electrical grid environmental agent 170 called “electricity” is associated with two devices cₑᵤᵣₒₛ and cₑₙᵥ respectively corresponding to the financial cost and to the environmental cost of the electrical energy originating from the grid. For example, the financial cost can be computed using an internal model reflecting the operation of peak/off-peak hours:

cₑᵤᵣₒₛ(t)=cₚₑₐₖ if t in peak hour,

c_{off-peak} if t in off-peak hour

with cₚₑₐₖ being the cost of the electricity in peak hours, and c_{off-peak} the cost of the electricity in off-peak hours. The environmental cost can for example correspond to the CO₂ emissions, a function of the consumed electrical kWh, and for a content distributed by season by usage (as defined in the ADEME document, RTE “The CO₂ content of the electrical kWh: advantages compared to the marginal content and the content by usage based on history”), corresponding to the following internal model:

cₑₙᵥ(t)=180 g/kWh for the heating and 40 g/kWh otherwise.

In this modelling, the cost of the electricity originating from the electrical grid is incorporated through an environmental agent 170 identified as “electricity”. However, it would be perfectly possible to incorporate the electricity in the modelling in agent form.

Finally, each of the actuator and sensor software representations is indeed associated with an agent. All the physical actuator elements 120 are therefore well controlled by the multi-agent control-command system 100.

Based on this modelling, the application of the regulation according to the process of the phase P2 handles the control of the installation.

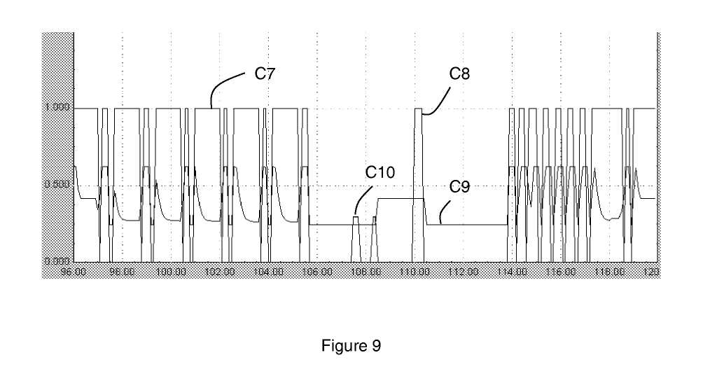

Finally, FIG. 8 represents the observed values of the temperature sensors of the installation over a 24-hour period.

More specifically:
the curve C1 corresponds to the trend over time of the temperature in the top zone of the tank Tₜₐₙₖ_{_{—}}_{T},
the curve C2 corresponds to the trend over time of the temperature in the middle zone of the tank Tₜₐₙₖ_{_{—}}_{M},
the curve C3 corresponds to the trend over time of the indoor temperature Tᵢₙₜ,
the curve C4 corresponds to the trend over time of the temperature in the bottom zone of the tank Tₜₐₙₖ_{_{—}}_{B},
the curve C5 corresponds to the trend over time of the temperature of the solar sensor Tₛₑₙₛₒᵣ,
and the curve C6 corresponds to the trend over time of the outdoor temperature Tₑₓₜ.

For its part, FIG. 9 represents the controls of the different actuator elements 120 of the installation computed by the control system 100 over the 24-hour period.

More specifically:
the curve C7 corresponds to the trend over time of the control of the heat pump 15, i.e. the software representation Ctrl_{HP},
the curve C8 corresponds to the trend over time of the control of the top-up electric heating element 16, i.e. the software representation Ctrl_{Relec},
the curve C9 corresponds to the trend over time of the control of the ventilation, i.e. the software representation Ctrlᵥₑₙₜ,

the curve C10 corresponds to the trend over time of the control of the solar circulator, i.e. the software representation Ctrl_{Solar}.

The invention described previously is a control method associated with a control system, making it possible to ensure the management of the actuator elements of an energy-managing installation. The aim is notably to manage the thermal elements of the buildings or of other installations using thermal systems such as, for example, the heat networks. The control system makes it possible to optimize this management according to different criteria other than only the energy consumption by incorporating the use of electrical and non-electrical energy sources. Furthermore, it takes account of the constraints linked to the energy distribution network and incorporates the distribution auxiliaries in the optimization process. Finally, the solution according to the invention makes it possible to design a system that can be reused between different installations and systems. For this, it emerges from the above that the method combines an agent-based description, and an optimization process relying on this description. The energy management installation, through its constituent elements, is described in the form of consuming agents, distributing agents, producing agents, and environmental agents. These agents incorporate models enabling them to compute in particular the needs, the resources or the cost associated with the consumption or with the production of thermal energy, making it possible to ensure for example the heating, cooling, ventilation or sanitary hot water production functions. By being based on this description, the system then uses a distributed process in order to optimize the production of energy, notably of thermal type, according to criteria previously chosen and potentially distinct from the overall energy consumption.

1. Method for controlling an energy management installation, comprising:
a modelling phase of the installation comprising:
a step of creating a multi-agent control system including at least energy consuming agents, energy distributing agents and energy producing agents representative at least of an operation associated with respectively energy consuming elements, energy distributing elements and energy producing elements of the installation, each of the agents incorporating a model implemented by a computer,
the models of the energy distributing agents taking into account characteristics concerning the energy distributing elements of the installation, including the energy distribution and/or consumption constraints and/or the financial and/or environmental distribution costs and/or the influence of the operation of the energy distributing elements on the operation of the energy producing elements,
a regulation phase of the installation comprising:
an optimization step using the models incorporated in the agents of the control system so as to optimize the way the energy is produced by the producing agents, the energy is distributed by the distributing agents and the energy is allocated to the consuming agents, as a function of optimization criteria based on the energy consumption of the installation and/or on at least one other criterion such as the cost of operation and/or the environmental cost of the installation and/or weather forecasts and/or comfort parameters and/or the observed and/or expected behaviour of the users of the installation,
a step of controlling the actuator elements of the installation based on the results of the optimization step from the implementation of the models incorporated in the agents.

2. Method according to claim 1, wherein the model associated with each distributing agent computes a distribution cost due to the energy transfer by the distributing agent and/or the resources necessary to the distributing agent, associated with a given energy need.

3. Method according to claim 1, wherein the model associated with each producing agent computes necessary resources that the producing agent can provide and/or a need for energy to be supplied to the producing agent to produce these necessary resources and/or a cost of production of the necessary resources.

4. Method according to claim 1, wherein the model associated with each consuming agent computes needs for energy to be supplied to the consuming agent and/or a satisfaction associated with resources received by the consuming agent.

5. Method according to claim 1, wherein the modelling phase of the installation comprises a step of establishing software representations associated with sensor elements and/or actuator elements of the installation.

6. Method according to claim 1, wherein the software representation associated with each sensor element and with each actuator element of the installation is associated with a history and with a forecast, the values of which can be observed by the agents of the control system.

7. Method according to claim 1, wherein the software representation associated with each sensor element and with each actuator element of the installation is associated with a single agent of the control system, the single agent being responsible for updating the software representation.

8. Method according to claim 1, wherein the agent with which the software representation associated with a given sensor element is associated contains a forecast model implemented by a computer.

9. Method according to claim 1, wherein the agent with which the software representation of a given actuator element is associated contains a planning model implemented by a computer.

10. Method according to claim 1, wherein the creation step comprises a step of supplying environmental agents used during the optimization step, belonging to the multi-agent control system and representative of parameters external to the installation, such as the financial cost associated with the energy from which the producing elements produce energy and/or the cost of operation and/or the environmental cost and/or weather forecasts and/or comfort parameters and/or the observed and/or expected behaviour of the users of the installation.

11. Method according to claim 1, wherein, prior to the optimization step, the regulation phase comprises a step of reception by the control system of the values originating from the sensor elements of the installation and a step of initialization of the control system based on the values received in the reception step.

12. Method according to claim 11, wherein the initialization step comprises a step of updating the control system during which each of the respective agents of the control system updates the forecast of the software representations associated with the sensor elements associated with the respective agent, based on the values received in the reception step and based on the implementation of the forecast model by a computer.

13. Method according to claim 12, wherein the initialization step comprises a step of determining:
forecasts of energy needs of the consuming agents by implementing the model of the consuming agents via a computer based on the forecasts of software representations associated with the sensor elements,
and/or forecasts of resources and/or of the associated costs of the producing agents by implementing the model of the producing agents via a computer based on forecasts of the software representations associated with the sensor elements.

14. Method according to claim 1, wherein the optimization step comprises at least one step of collecting, for each of the distributing agents, forecasts of energy needs of its “client” agents, based on forecasts of energy needs of the consuming agents and on forecasts of resources of its energy “supplying” agents, based on forecasts of resources of the producing agents.

15. Method according to claim 14, wherein the steps of collecting forecasts of needs and of forecasting of resources are repeated alternately, by successive iterations at the level of the distributing agents.

16. Method according to claim 14, wherein the optimization step comprises a step of adjusting the forecasts of resources of the “supplying” agents and the forecasts of energy needs of the “client” agents during which, based on the forecasts of available resources of the producing agents, the distributing agents optimize, with their “supplying” agents, the resources making it possible to meet the energy needs of their “client” agents.

17. Method according to claim 14, comprising a step of selection of the resources, by the distributing agents, based on the optimization criteria.

18. Method according to claim 17, wherein the optimization step comprises an allocation step consisting in assigning to the “client” agents the resources selected in the selection step and possibly a step of checking the satisfaction of the consuming agents and/or of the “client” agents receiving the resources assigned in the allocation step.

19. Method according to claim 18, wherein the optimization step comprises a step of putting in place a planning of the resources to be received and/or to be produced by the producing, distributing and consuming agents, each planning being established on the basis of the resources assigned in the allocation step and corresponding to a state of the actuator elements of the installation.

20. Method according to claim 19, comprising a step of transmission of control commands by the control system to the actuator elements, the control commands being configured so as to place each of the actuator elements in the state corresponding to the planning previously put in place.

21. Method according to claim 1, wherein the regulation phase comprises a step of selecting the optimization criteria and a step of acquisition by the control system of the optimization criteria selected in the selection step.

22. System for controlling an energy management installation, comprising software and/or hardware elements which implement the control method according to claim 1.

23. System according to claim 22, wherein the system is a management system managing either the thermal systems of a building, the consuming elements being taken from, for example, heating and/or ventilation and/or air conditioning and/or sanitary hot water production elements, or a heat network, or an installation coupling thermal energy and electrical energy.

24. Computer-readable data storage medium, on which is stored a computer program comprising computer program code means for implementing the phases and/or steps of a method according to claim 1.

25. Computer program comprising a computer program code means suitable for carrying out the phases and/or steps of a method according to claim 1, when the program is run on a computer.
